(19) United States
(12) Patent Application Publication
(10) Pub. No.: US 2009/0116346 A1
(43) Pub. Date: May 7, 2009

(54) OPTICAL RECORDING/PLAYBACK DEVICE AND MEDIUM DIFFERENTIATION METHOD

(75) Inventors: Kazuo Takahashi, Saitama (JP); Tetsuo Ishii, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku , Tokyo (JP)

(21) Appl. No.: 12/295,613

(22) PCT Filed: Mar. 16, 2007
(86) PCT No.: PCT/JP2007/055411

§ 371 Date: Nov. 7, 2008

(30) Foreign Application Priority Data
Mar. 30, 2006 (JP) 2006-093762

(51) Int. Cl. G11B 7/00

(52) U.S. Cl. 369/44.23; 369/112.23; G9B/7

(57) ABSTRACT

There is provided a recording/playback device able to differentiate the type of an optical disc or another such optical recording medium with a high degree of precision while correcting wavefront aberrations. The recording/playback device has a detection part for sequentially detecting the surface of a cover layer and one or a plurality of signal recording surfaces of an object to be detected on the basis of an output signal of a photodetector, a medium differentiation part for differentiating the type of the detected object on the basis of the detection results, an aberration correction element, and an aberration control part for controlling the aberration correction state of the aberration correction element. When the focal point of the light beam moves toward the signal recording surface, the aberration control part sets the aberration correction state of the aberration correction element to a state between a first aberration correction state in which the wavefront aberrations are appropriately corrected in accordance with a surface of a cover layer of a predetermined optical recording medium, and a second aberration correction state in which the wavefront aberrations are appropriately corrected in accordance with a signal recording surface of the predetermined optical recording medium.

### TECHNICAL FIELD

The present invention relates to an optical recording/playback device which can differentiate the type of an optical disc or another such optical recording medium, and to a differentiation method thereof.

### BACKGROUND ART

An optical recording/playback device is a device for recording information on an optical disc or another such optical recording medium, or for reading the recorded information from the optical recording medium. There are many various types of optical discs, including, e.g., CDs (compact discs), DVDs (digital versatile discs), BDs (Blu-ray discs), and AODs (advanced optical discs), and several methods have been proposed for differentiating the type of these optical discs, which is one function of an optical recording/playback device. For example, there are methods for cases in which optical reflectivity differs depending on the type of optical disc, in which case the reflected light from the optical disc is detected and the type of optical disc is differentiated based on the detection results. There are also methods for cases in which information indicating the type of optical disc has been recorded in advance on the optical disc, in which case the type of optical disc is differentiated based on the information read from the optical disc. Furthermore, there are methods for cases in which a cover layer for covering the signal recording surface of the optical disc has a different thickness depending on the type of optical disc, in which case the thickness of the cover layer is detected and the type of optical disc is differentiated based on the detection results. Conventional techniques pertaining to differentiating the types of optical discs are disclosed in, e.g., Patent Document 1 (Japanese Patent Kokai No. 8-287588), Patent Document 2 (Japanese Patent Kokai No. 2004-111028), and Patent Document 3 (United States Patent Application No. 2004/037197, Description).

Patent Document 1 discloses a determining device for detecting the thickness of a cover layer covering the signal recording surface and for differentiating the type of optical disc on the basis of the detection results. This determination device has a light-receiving element for detecting returning light reflected by the optical disc when a light beam is reflected by the optical disc, and comparison means for comparing the output signal level of the light-receiving element with two threshold levels. One of the two threshold levels is a level for detecting the substrate surface of the optical disc, and the other threshold level is a level for detecting the signal recording surface. This determination device has a function for measuring the time difference from the point in time when reflected light from the substrate surface of the optical disc is detected until the point in time when reflected light from the signal recording surface of the optical disc is detected, when the focal point of the light beam has approached the optical disc at a constant speed; and for detecting the substrate thickness of the optical disc on the basis of the time difference.

However, when the effects of a wavefront aberration distort the waveform of the output signal of the light-receiving element, there are cases in which the waveform distortion causes a failure to detect the substrate surface or signal recording surface of the optical disc. Particularly, when a spherical aberration occurs as a result of errors in the cover layer thickness in the optical disc, problems are encountered in which the output signal level of the light-receiving element becomes unstable, leading to a failure to determine the class of optical disc or to an erroneous determination of the class of optical disc. Since the optical reflectivity of the substrate surface of the optical disc is commonly less than that of the signal recording surface, the amplitude of the signal obtained from the reflected light from the substrate surface is small and susceptible to the effects of the spherical aberration. Consequently, there is a high probability of failure in detecting the substrate surface. In cases in which substrate surface detection fails and the signal recording surface is erroneously detected as the substrate surface, there is a danger that the objective lens will collide with the optical disc while the objective lens is being transferred toward the optical disc in order to detect the signal recording surface.

The rate of occurrence of spherical aberrations is proportional to NA⁴×d/λ, wherein d is the thickness of the cover layer of the optical disc, λ is the wavelength of the optical beam, and NA is the numerical aperture of the objective lens. It is expected that with next-generation optical disc standards, the numerical aperture NA of the objective lens will be further increased and the wavelength λ of the laser light source will be further shortened in order to improve recording density, and therefore the demand is that spherical aberrations be corrected at a high level and that the classes of optical discs be determined with greater precision.

Patent Document 2 discloses a method for using the signal waveform distortion caused by the spherical aberrations to determine the class of optical disc. In this method, spherical aberrations are appropriately corrected in accordance with the average value (reference depth) of the depth of the information surfaces (signal recording surfaces) of the types of optical discs that can be loaded. Specifically, when an optical disc having an information surface at the reference depth is loaded, the rate of occurrence of spherical aberrations is adjusted to a minimum, and the distribution of the signal waveform expressing the received amount of light reflected by the information surface is symmetrical. When an optical disc having an information surface at a position deeper or shallower than the reference depth is loaded, the distribution of the signal waveform expressing the received amount of light reflected by the information surface is not symmetrical, but is instead asymmetrical. Consequently, it is possible to differentiate the type of optical disc in accordance with the extent of asymmetry in the signal waveform.

However, it is not always possible to accurately correct the spherical aberrations in accordance with the reference depth of the information surfaces of the optical discs so that the distribution of the signal waveform will be symmetrical, and there are cases in which it is not possible to precisely differentiate the type of optical disc without achieving the desired signal waveform asymmetry.

### Patent Document 1: Japanese Patent Kokai No. 8-287588

### Patent Document 2: Japanese Patent Kokai No. 2004-111028

Patent Document 3: United States Patent Application No. 2004/037197, Description (a laid-open publication pertaining to a United States Patent Application based on the Application of Patent Document 2)

### DISCLOSURE OF THE INVENTION

With the foregoing aspects of the prior art in view, it is a primary object of the present invention to provide an optical recording/playback device and a medium differentiation method whereby wavefront aberrations can be corrected and the type of an optical disc or another such optical recording medium can be differentiated with high precision.

The optical recording/playback device according to a first aspect of the present invention is an optical recording/playback device for recording information onto an optical recording medium having at least one signal recording surface covered by a cover layer, or for playing back the recorded information from the optical recording medium; the device comprising a light source for emitting a light beam to be directed onto an optical recording medium that is an object to be detected, an objective lens for focusing the light beam from the light source, a lens drive part for moving the focal point of the light beam directed from the objective lens from a predetermined position outside of the surface of the cover layer toward the signal recording surface, a photodetector for detecting a returning light beam reflected by the optical recording medium, a detection part for sequentially detecting the surface of the cover layer and one or a plurality of signal recording surfaces of the optical recording medium on the basis of an output signal of the photodetector when the focal point of the light beam moves from the predetermined position toward the signal recording surface, a medium differentiation part for differentiating the type of the optical recording medium on the basis of the detection results of the detection part, an aberration correction element for modulating a phase of the light beam to be directed onto the optical recording medium and for correcting wavefront aberrations, and an aberration control part for controlling an aberration correction state of the aberration correction element; wherein when the lens drive part moves the focal point of the light beam from the predetermined position toward the signal recording surface, the aberration control part sets the aberration correction state of the aberration correction element to a state between a first aberration correction state in which the wavefront aberrations are corrected in accordance with a surface of a cover layer of a predetermined optical recording medium, and a second aberration correction state in which the wavefront aberrations are corrected in accordance with a signal recording surface of the predetermined optical recording medium.

The optical recording/playback device according to a second aspect of the present invention is an optical recording/playback device for recording information onto an optical recording medium having at least one signal recording surface covered by a cover layer, or for playing back the recorded information from the optical recording medium; the device comprising a light source for emitting a light beam to be directed onto an optical recording medium that is an object to be detected, an objective lens for focusing the light beam from the light source, a lens drive part for moving the focal point of the light beam directed from the objective lens from a predetermined position outside of the surface of the cover layer toward the signal recording surface, a photodetector for detecting a returning light beam reflected by the optical recording medium, a detection part for sequentially detecting the surface of the cover layer and one or a plurality of signal recording surfaces of the optical recording medium on the basis of an output signal of the photodetector when the focal point of the light beam moves from the predetermined position toward the signal recording surface, a medium differentiation part for differentiating the type of the optical recording medium on the basis of the detection results of the detection part, an aberration correction element for modulating a phase of the light beam to be directed onto the optical recording medium and for correcting wavefront aberrations, and an aberration control part for controlling an aberration correction state of the aberration correction element; wherein when the lens drive part initiates movement of the focal point of the light beam from the predetermined position toward the signal recording surface, the aberration control part sets the aberration correction state of the aberration correction element to a first aberration correction state in which the wavefront aberrations are corrected in accordance with a surface of a cover layer of a predetermined optical recording medium; and after the detection part has detected the surface of the cover layer of the detected object, the aberration control part gradually changes the aberration correction state of the aberration correction element from the first aberration correction state toward a second aberration correction state in which the wavefront aberrations are corrected in accordance with a signal recording surface of the predetermined optical recording medium, in synchronization with the movement of the focal point of the light beam.

The medium differentiation method according to a third aspect of the present invention is a medium differentiation method for differentiating a type of an object to be detected in an optical recording/playback device comprising a light source for emitting a light beam to be directed onto an optical recording medium as the detected object having at least one signal recording surface covered by a cover layer, an objective lens for focusing the light beam from the light source, a lens drive part for moving the focal point of the light beam directed from the objective lens from a predetermined position outside of the surface of the cover layer toward the signal recording surface, a photodetector for detecting a returning light beam reflected by the detected object, and an aberration correction element for modulating a phase of the light beam to be directed onto the detected object and for correcting wavefront aberrations; the method comprising (a) a step for setting the aberration correction state of the aberration correction element to a state between a first aberration correction state in which the wavefront aberrations are corrected in accordance with a surface of a cover layer of a predetermined optical recording medium, and a second aberration correction state in which the wavefront aberrations are corrected in accordance with a signal recording surface of the predetermined optical recording medium, when the lens drive part moves the focal point of the light beam from the predetermined position toward the signal recording surface; (b) a step for sequentially detecting the surface of the cover layer and one or a plurality of signal recording surfaces of the detected object on the basis of an output signal of the photodetector, when the lens drive part moves the focal point of the light beam from the predetermined position toward the signal recording surface; and (c) a step for differentiating the type of the detected object on the basis of the detection results of step (b).

The medium differentiation method according to a fourth aspect of the present invention is a medium differentiation method for differentiating the type of an object to be detected in an optical recording/playback device comprising a light source for emitting a light beam to be directed onto an optical recording medium as the detected object having at least one signal recording surface covered by a cover layer, an objective lens for focusing the light beam from the light source, a lens drive part for moving the focal point of the light beam directed from the objective lens from a predetermined position outside of the surface of the cover layer toward the signal recording surface, a photodetector for detecting a returning light beam reflected by the optical recording medium, and an aberration correction element for modulating a phase of the light beam to be directed onto the optical recording medium and for correcting wavefront aberrations; the method comprising (a) a step for setting the aberration correction state of the aberration correction element to a first aberration correction state in which the wavefront aberrations are corrected in accordance with a surface of a cover layer of a predetermined optical recording medium when the lens drive part initiates movement of the focal point of the light beam from the predetermined position toward the signal recording surface; (b) a step for detecting the surface of the cover layer of the detected object on the basis of an output signal of the photodetector when the lens drive part moves the focal point of the light beam from the predetermined position toward the signal recording surface; (c) a step for gradually changing the aberration correction state of the aberration correction element from the first aberration correction state toward a second aberration correction state in which the wavefront aberrations are corrected in accordance with a signal recording surface of the predetermined optical recording medium, in synchronization with movement of the focal point of the light beam, after the surface of the cover layer has been detected in step (b); (d) a step for detecting one or a plurality of signal recording surfaces of the detected object on the basis of an output signal of the photodetector when the lens drive part moves the focal point of the light beam from the surface of the cover layer toward the signal recording surface; and (e) a step for differentiating the type of the detected object on the basis of the detection results of steps (b) and (d).

### BRIEF DESCRIPTION OF THE DRAWINGS

FIG. 1 is a block diagram showing a schematic configuration of an optical recording/playback device of an embodiment according to the present invention;

FIG. 2 is a schematic cross-sectional view of a liquid-crystal correction element;

FIG. 3 is a drawing showing an example of an electrode pattern for correcting spherical aberrations;

FIG. 4(A) is a graph schematically depicting the relationship between the cover layer thickness and the point indicating an aberration correction state (corrective action point), and FIGS. 4(B) through 4(D) are drawings schematically depicting the cross-sectional structure of a two-layer optical disc;

FIGS. 5(A) through 5(H) are diagrams showing the waveforms of the sum signal and the waveforms of the focus error signal that result when the focal point of the light beams is moved;

FIGS. 6(A) through 6(E) are diagrams showing various signal waveforms that occur when the focal point of the light beams is moved;

FIG. 7 is a flowchart schematically depicting the sequence of the differentiation process of the first embodiment according to the present invention;

FIGS. 8(A) through 8(E) are timing charts schematically depicting the signal waveforms generated in the differentiation process of the first embodiment;

FIG. 9 is a flowchart schematically depicting the sequence of the differentiation process of the second embodiment according to the present invention;

FIGS. 10(A) through 10(E) are timing charts schematically depicting the signal waveforms generated in the differentiation process of the second embodiment;

FIG. 11 is a flowchart schematically depicting the sequence of the differentiation process of the third embodiment according to the present invention;

FIGS. 12(A) through 12(E) are timing charts schematically depicting the signal waveforms generated in the differentiation process of the third embodiment;

FIG. 13 is a flowchart schematically depicting the sequence of the differentiation process of a modification of the third embodiment; and

FIGS. 14(A) through 14(E) are timing charts schematically depicting the signal waveforms generated in the differentiation process of the modification of the third embodiment.

### EXPLANATION OF SIGNS

1 Optical recording/playback device
2 Optical recording medium (optical disc)
3 Optical pickup
11A, 11B Laser light source
16 Liquid-crystal correction element
18 Objective lens
18A Selective filter
20 Actuator
22 Photodetector
25A, 25B Light source driver
30 Controller
31 Signal generator
32 Aberration control part
33 Nonvolatile memory
34 Lens drive control part
35 Surface detection part
36 Disc differentiation part

### MODE FOR CARRYING OUT THE INVENTION

The present application is based on Japanese Patent Application No. 2006-93762 as a priority application, and the details of the basis application are incorporated in the present application.

Various embodiments according to the present invention are described hereinbelow.

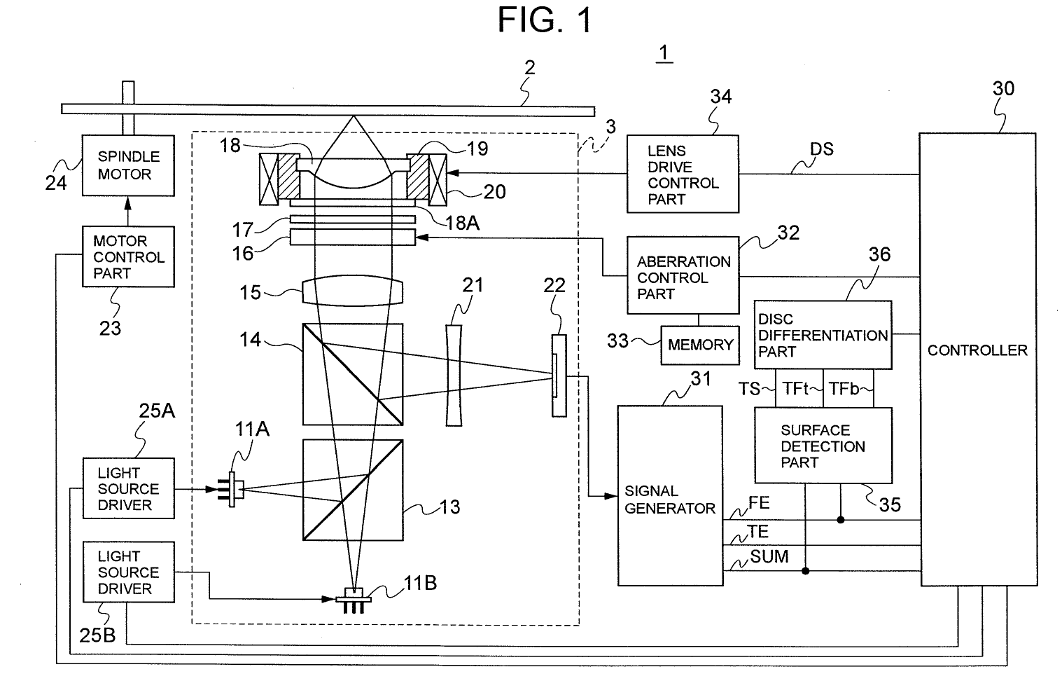

FIG. 1 is a block diagram showing the schematic configuration of an optical recording/playback device 1 (hereinbelow referred to as “recording/playback device 1”) of an embodiment according to the present invention. The recording/playback device 1 has an optical pickup 3, a motor control part 23, a spindle motor 24, a first light source driver 25A, a second light source driver 25B, a controller 30, a signal generator 31, an aberration control part 32, a lens drive control part 34, a surface detection part 35, and a disc differentiation part (medium differentiation part) 36. The controller 30 has the function of controlling the actions of these structural elements 23, 25A, 25B, 31, 32, 34, 35, 36, and can be a microcomputer, for example. In the present embodiment, the controller 30 is configured separately from the surface detection part 35, the disc differentiation part 36, the aberration control part 32, and the lens drive control part 34, but these elements may be combined with the controller 30 in a single microcomputer.

The optical pickup 3 includes a first laser light source 11A, a second laser light source 11B, a synthetic prism (dichroic prism) 13, a beam splitter 14, a collimator lens 15, a liquid-crystal correction element 16, a quarter wavelength plate 17, an objective lens 18, a selective filter 18A, a sensor lens 21, and a photodetector 22. The objective lens 18 is fixed to a lens holder 19, and the lens holder 19 is attached to an actuator 20 for biaxial or triaxial driving. The actuator 20 is controlled by the lens drive control part 34, and is capable of driving the objective lens 18 in the focus direction (the direction approaching an optical recording medium 2 or the direction opposite thereto), in the radial direction (the diametral direction of the optical recording medium 2, orthogonal to the focus direction), and in the tangential direction (the direction orthogonal to both the focus direction and the radial direction).

The optical recording medium (optical disc) 2 is placed on a turntable (not shown) of a disc mount. The spindle motor 24 rotatably drives the optical disc 2 around a center axis in accordance with a drive signal supplied from the motor control part 23. Possible examples of the type of optical recording medium 2 include, but are not limited to, a CD (compact disc), a DVD (digital versatile disc), a BD (Blu-ray disc), and an AOD (advanced optical disc). The optical recording medium 2 has either one or a plurality of signal recording layers, and a cover layer for covering the signal recording layer(s).

The recording/playback device 1 of the present embodiment can differentiate the type of the mounted optical disc 2 in accordance with the thickness of the cover layer of the optical disc 2. Whether the first laser light source 11A or the second laser light source 11B is used depends on the type of the optical disc 2. The first laser light source 11A emits a light beam having a first oscillation wavelength (for example, approximately 650 nm according to the DVD standard), in accordance with a drive signal supplied from the first light source driver 25A. This light beam is reflected by the synthetic prism 13, and is then directed via the beam splitter 14 to the collimator lens 15. The light beams emitted from the beam splitter 14 are converted to parallel light beams by the collimator lens 15, which are then directed to the liquid-crystal correction element 16. The liquid-crystal correction element 16 has the function of modulating the phases of the incoming light beams and correcting the wavefront aberrations. The quarter wavelength plate 17 converts the light beams from the liquid-crystal correction element 16 from linearly polarized light to circularly polarized light, and then emits the light to the selective filter 18A. The objective lens 18 focuses the light beams coming through the selective filter 18A onto the optical disc 2.

The second laser light source 11B emits a light beam having a second oscillation wavelength (for example, approximately 407 nm according to the BD standard) shorter than the first oscillation wavelength, in accordance with a drive signal supplied from the second light source driver 25B. This light beam is directed via the synthetic prism 13 and the beam splitter 14 to the collimator lens 15. The light beams emitted from the beam splitter 14 are converted to parallel light beams by the collimator lens 15, which are then directed to the liquid-crystal correction element 16. The liquid-crystal correction element 16 modulates the phases of the incoming light beams and corrects the wavefront aberrations. The modulated light beams are directed via the quarter wavelength plate 17 and the selective filter 18A to the objective lens 18. The objective lens 18 focuses the incident light beams from the selective filter 18A onto the optical disc 2.

The selective filter 18A is an optical element having an orbicular diffractive structure, and the filter achieves a numerical aperture suited to the light source wavelength corresponding to the optical disc 2. For example, according to the CD standard, the light source wavelength can be set to approximately 780 nm and the numerical aperture to 0.45; according to the DVD standard, the light source wavelength can be set to approximately 650 nm and the numerical aperture to 0.60; and according to the BD standard, the light source wavelength can be set to approximately 407 nm and the numerical aperture to 0.85. Another possibility is to use an objective lens 18 having, instead of the selective filter 18A, a diffractive lens structure in which orbicular ridges are formed on one surface. An objective lens having the selective filter 18A or a diffractive lens structure is disclosed in, e.g., Japanese Patent Kokai No. 2004-362732 (also in the Description of the corresponding United States Laid-open Application No. 2004/223442, or in the corresponding Chinese Application Laid-open No. 1551156).

The returning light beams reflected by the optical disc 2 passes sequentially through the objective lens 18, the quarter wavelength plate 17, the liquid-crystal correction element 16, and the collimator lens 15, and is led by the beam splitter 14 to the sensor lens 21. The returning light beams from the sensor lens 21 are detected by the photodetector 22 after being refracted by the sensor lens 21. The photodetector 22 photoelectrically converts the returning light beams and generates an electric signal, and the electric signal is sent to the signal generator 31.

Based on the electric signal from the photodetector 22, the signal generator 31 generates a sum signal SUM that indicates the total amount of light received from the returning light beams, a tracking error signal TE, and a focus error signal FE. The tracking error signal TE can be detected using, e.g., a conventional push-pull method, and the focus error signal FE can be detected using, e.g., an astigmatic method or a differential astigmatic method. Based on the tracking error signal, the controller 30 and the lens drive control part 34 can execute a tracking servo for driving the objective lens 18 and causing the focal point of the light beams to follow the recording track of the optical disc 2. Based on the focus error signal FE, the controller 30 and the lens drive control part 34 can execute a focus servo for driving the objective lens 18 and causing the focal point of the light beams to coincide with the target surface of the optical disc 2.

In cases in which wobbling having a shape which undulates at a constant amplitude and a constant spatial frequency is formed in the guide grooves or between the guide grooves of the optical disc 2, the signal generator 31 detects the wobbling pattern on the basis of an output signal of the photodetector 22 and sends an associated detection signal (wobble signal) to the controller 30. In cases in which lands having land pre-pits are formed in the optical disc 2, the signal generator 31 can detect the land pre-pit on the basis of the output signal of the photodetector 22, and can send a detection signal (pre-pit signal) thereof to the controller 30. The controller 30 can use these detection signals to execute various servo controls.

The surface detection part 35 has the function of detecting the surface of the cover layer and the surface(s) of one or a plurality of signal recording layers (signal recording surfaces) of the optical disc 2 by observing the level of the focus error signal FE or the sum signal SUM. The disc differentiation part 36 differentiates the type of the optical disc 2 on the basis of the detection results of the surface detection part 35, and notifies the controller 30 of the differentiation results.

The lens drive control part 34 is capable of driving the actuator 20 in accordance with a drive signal DS from the controller 30 to move the objective lens 18 toward the optical disc 2, and of driving the actuator 20 in accordance with a drive signal DS from the controller 30 to move the objective lens 18 away from the optical disc 2. Consequently, the lens drive control part 34 is capable of moving the focal point of the light beams directed onto the optical disc 2 in the focus direction within a predetermined range. A “lens drive part” of the present invention can be configured from the actuator 20 and the lens drive control part 34.

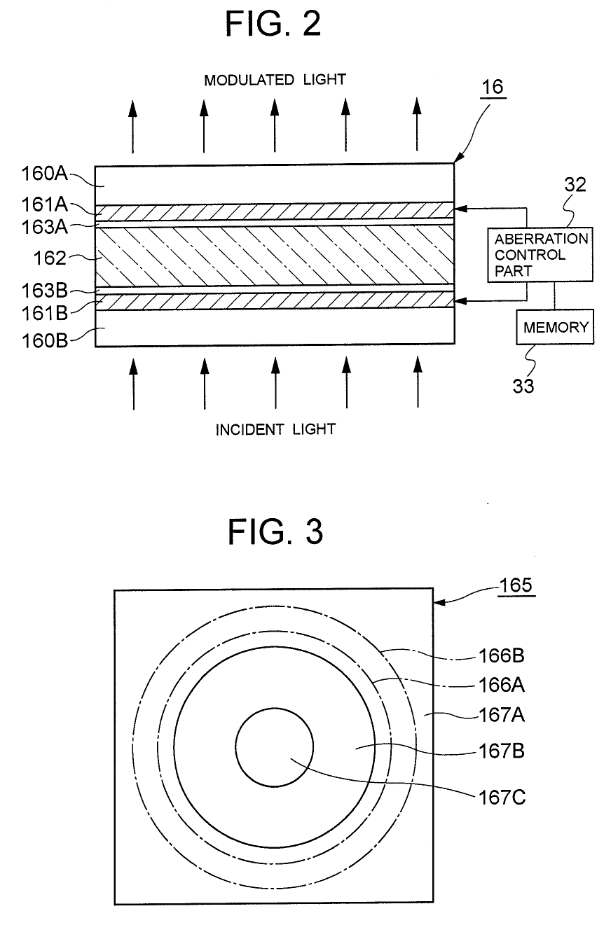

The liquid-crystal correction element 16 is an element for modulating the phases of the incident light beams and correcting wavefront aberrations. Examples of wavefront aberrations include astigmatism caused by deviation from the shape or designed position of the optical component leading the light beams to the optical disc 2, coma aberrations caused by inclination from the normal direction light axis on the signal recording surface of the optical disc 2, spherical aberrations caused by errors in the thickness of the cover layer covering the signal recording surface of the optical disc 2, and the like. The liquid-crystal correction element 16 has first and second optically transparent substrates 160A, 160B which face each other across a gap, a first electrode layer 161A formed on the inside surface of the first optically transparent substrate 160A, an insulating layer 163A formed on the inside surface of the first electrode layer 161A, a second electrode layer 161B formed on the inside surface of the second optically transparent substrate 160B so as to face the first electrode layer 161A, an insulating layer 163B formed on the inside surface of the second electrode layer 161B, and a liquid-crystal layer 162 disposed between the first and second electrode layers 161A, 161B via the insulating layers 163A, 163B, as shown schematically in FIG. 2. The first electrode layer 161A and the second electrode layer 161B are composed of ITO (indium tin oxide: tin added to indium oxide) or another such metal oxide, and the first insulating layer 163A and the second insulating layer 163B are composed of a polyimide or another such optically transparent insulating material. The liquid-crystal layer 162 includes birefringent liquid crystal molecules, and these liquid-crystal molecules are oriented by orientation films (not shown) formed on the inside surfaces of the insulating layers 163A, 163B.

At least one of the first and second electrode layers 161A, 161B has an electrode pattern composed of a plurality of electrode segments. For example, the first electrode layer 161A can have an electrode pattern composed of a plurality of electrode segments, and the second electrode layer 161B can be made into an electrode layer which is continuous across the entire surface. FIG. 3 shows an example of an electrode pattern 165 for correcting spherical aberrations. The electrode pattern 165 is configured from three electrode segments 167A, 167B, 167C disposed within aperture-limiting areas 166A, 166B. The aberration control part 32 can apply a drive voltage individually to the electrode segments 167A, 167B, 167C. One aperture-limiting area 166A corresponds to the wavelength of light emitted by the first laser light source 11A, and the other aperture-limiting area 166B corresponds to the wavelength of light emitted by the second laser light source 11B.

The aberration control part 32 generates drive voltages to be supplied respectively to the first and second electrode layers 161A, 161B, in accordance with values of a correction data set read from nonvolatile memory 33. An electrical field distribution is formed in the liquid-crystal layer 162 between the first electrode layer 161A and the second electrode layer 161B, in accordance with the drive voltages supplied from the aberration control part 32. The liquid-crystal molecules in the liquid-crystal layer 162 are oriented according to the electrical field distribution, and a refractive index distribution corresponding to the state of orientation is formed. The optical path length of the light beams is proportionate to the product of refractive index of the light transmissive medium and the geometric distance thereto, and the phases of the light beams passing through the liquid-crystal layer 162 are therefore modulated according to the refractive index distribution.

In the present embodiment, the liquid-crystal correction element 16 is used as the preferred means of correcting wavefront aberrations, but the present invention is not limited to this option alone. Instead of the liquid-crystal correction element 16, a phase modulation means using, e.g., an expander lens or a collimator lens may also be used.

The aberration control part 32 can control the state of the refractive index distribution in which wavefront aberrations in the liquid-crystal layer 162 of the liquid-crystal correction element 16 can be corrected (aberration correction state). A plurality of correction data sets respectively corresponding to the plurality of aberration correction states are stored in the nonvolatile memory 33. The aberration control part 32 selectively reads correction data sets from the nonvolatile memory 33, generates drive voltages in accordance with the read correction data sets, and supplies the drive voltages to the liquid-crystal correction element 16. The result is that the liquid-crystal correction element 16 operates so as to form an aberration correction state corresponding to the correction data set.

As described above, it is known that the rate of occurrence of spherical aberrations is proportional to the thickness of the cover layer covering the signal recording surface of the optical disc 2. Therefore, according to the thickness of the cover layer, spherical aberrations are appropriately corrected in accordance with the target surface to be detected. FIG. 4(A) is a graph schematically depicting the relationship between the cover layer thickness Dx, and a point Xc indicating the aberration correction state in which spherical aberrations are appropriately corrected in the liquid-crystal correction element 16 (hereinbelow referred to as the corrective action point). The cover layer thickness Dx in this graph is a parameter denoting the distance from the surface of the optical disc 2 to the target surface, and does not necessarily denote the thickness of the cover layer of the actually mounted optical disc 2.

The curve Dc shown in FIG. 4(A) indicates the relationship between the cover layer thickness Dx and the corrective action point Xc. The corrective action point X0 corresponding to a cover layer thickness of zero (Dx=0) implies a state in which the surface of the optical disc 2 is the target surface, and spherical aberrations are appropriately corrected in accordance with the surface. However, there are physical limitations on drive range in which the actual liquid-crystal correction element 16 can appropriately correct spherical aberrations. For example, in cases in which the drive range of the liquid-crystal correction element 16 spans from the corrective action point Xmin corresponding to the thickness Dmin to the corrective action point Xmax corresponding to the thickness Dmax as shown in FIG. 4(A), the aberration correction state in which spherical aberrations are appropriately corrected in accordance with the surface of the optical disc 2 is the corrective action point Xmin closest to the corrective action point X0.

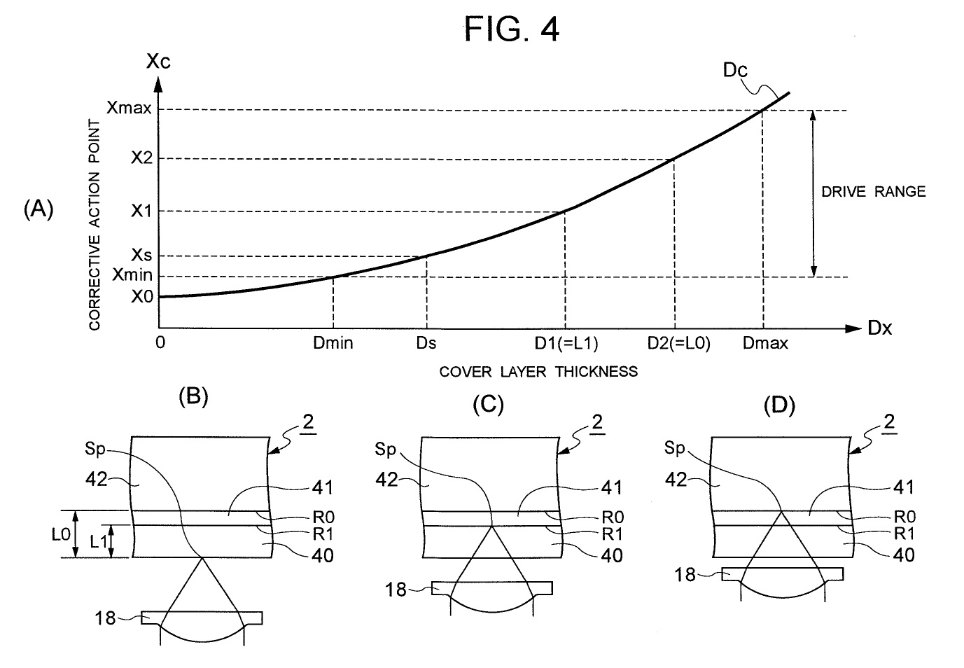

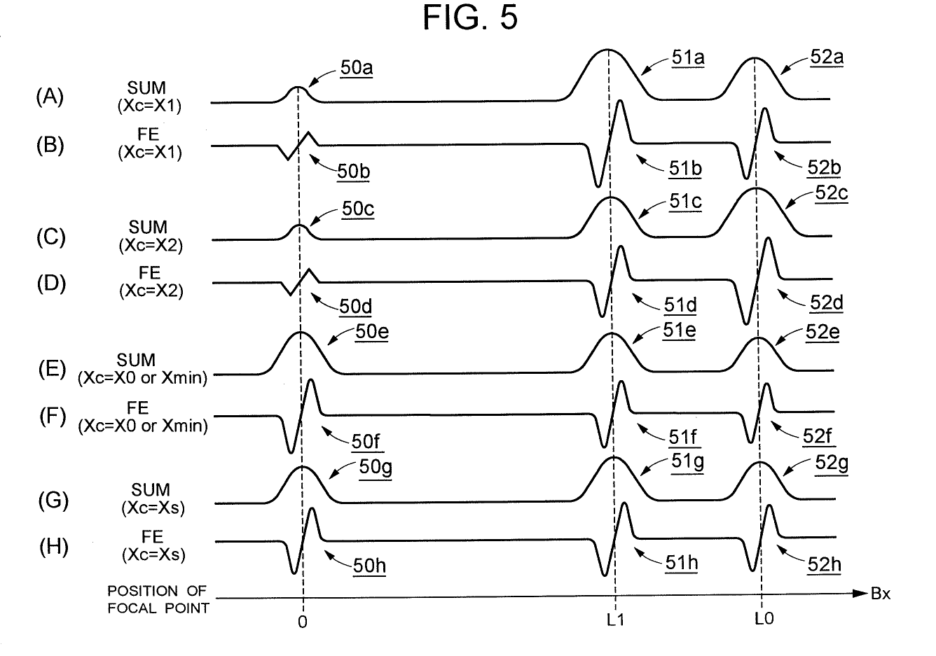

FIGS. 4(B), 4(C), and 4(D) are drawings schematically depicting the cross-sectional structure of an optical disc 2 having two signal recording layers. In this optical disc 2, a substrate 42, a signal recording layer having a first signal recording surface R0, a middle layer 41, a signal recording layer having a second signal recording surface R1, and a protective layer 40 are formed in the stated order. FIG. 5 is a diagram schematically depicting the waveform of the sum signal SUM and the waveform of the focus error signal FE which result when the focal point Sp of the light beams is moved from a position outside of the protective layer 40 of the optical disc 2 in FIGS. 4(B) through 4(D) toward the second signal recording surfaces R1, R0. FIG. 4(B) shows the state when the objective lens 18 is at a position focused at the surface of the protective layer 40, FIG. 4(C) shows the state when the objective lens 18 is at a position focused at the second signal recording surface R1, and FIG. 4(D) shows the state when the objective lens 18 is at a position focused at the first signal recording surface R0.

In cases in which spherical aberrations are appropriately corrected in accordance with the surface of the second signal recording surface R1 of the optical disc 2 (in other words, in cases in which the corrective action point Xc is set to “X1” corresponding to the cover layer thickness L1), the sum signal SUM and the focus error signal FE exhibit waveforms such as those shown in FIGS. 5(A) and 5(B). The sum signal SUM shown in FIG. 5(A) exhibits the respective signal waveforms 50a, 51a, 52a when the focal point Sp passes through the surface of the protective layer 40, the second signal recording surface R1, and the first signal recording surface R0 in the stated order. The focus error signal FE shown in FIG. 5(B) exhibits the respective S-shaped signal waveforms 50b, 51b, 52b when the focal point Sp passes through the surface of the protective layer 40, the second signal recording surface R1, and the first signal recording surface R0 in the stated order. When the focal point Sp of the light beams passes through the surface of the protective layer 40, the sum signal SUM exhibits a signal waveform 50a having an extremely small amplitude, and the focus error signal FE exhibits a signal waveform 50b having an extremely small amplitude corresponding to the signal waveform 50a, as shown in the diagram. When the focal point Sp passes through the signal recording surfaces R1, R0, the sum signal SUM exhibits signal waveforms 51a, 52a having large amplitudes, and the focus error signal FE exhibits signal waveforms 51b, 52b having large amplitudes. The amplitudes of the waveforms 50a, 50b corresponding to the surface of the protective layer 40 are extremely small in comparison with those of the waveforms 51a, 51b, 52a, 52b corresponding to the signal recording surfaces R1, R0. Consequently, in this case, it is easy to detect the signal recording surfaces R1, R0, but it is difficult to detect the surface of the protective layer 40.

Next, in cases in which spherical aberrations are appropriately corrected in accordance with the first signal recording surface R0 (in other words, in cases in which the corrective action point Xc is set to “X2” corresponding to the cover layer thickness L0), the sum signal SUM and the focus error signal FE exhibit waveforms such as those shown in FIGS. 5(C) and 5(D), respectively. The sum signal SUM shown in FIG. 5(C) respectively exhibits the signal waveforms 50c, 51c, 52c when the focal point Sp passes through the surface of the protective layer 40, the second signal recording surface R1, and the first signal recording surface R0 in the stated order. The focus error signal FE shown in FIG. 5(D) respectively exhibits the S-shaped signal waveforms 50d, 51d, 52d when the focal point Sp passes through the surface of the protective layer 40, the second signal recording surface R1, and the first signal recording surface R0 in the stated order. When the focal point Sp of the light beams passes through the surface of the protective layer 40, the sum signal SUM exhibits a signal waveform 50c having an extremely small amplitude, and the focus error signal FE exhibits a signal waveform 50d having an extremely small amplitude corresponding to the signal waveform 50c, as shown in the diagram. When the focal point Sp passes through the signal recording surfaces R1, R0, the sum signal SUM exhibits signal waveforms 51c, 52c having large amplitudes, and the focus error signal FE exhibits signal waveforms 51d, 52d having large amplitudes. The amplitudes of the waveforms 50c, 50d corresponding to the surface of the protective layer 40 are extremely small in comparison with those of the waveforms 51c, 52d, 51c, 52d corresponding to the signal recording surfaces R1, R0. Consequently, in this case as well, it is easy to detect the signal recording surfaces R1, R0, but it is difficult to detect the surface of the protective layer 40.

During usual recording and playback, spherical aberrations are appropriately corrected in accordance with the signal recording surfaces R1, R0 or with surfaces in proximity thereto, as shown in FIGS. 5(A) through 5(D). When the objective lens 18 is transferred in this aberration correction state, amplitudes are extremely small in the signal waveforms 50a, 50b, 50c, 50d corresponding to the surface of the protective layer 40 having low optical reflectivity, and there is therefore a high possibility of failure in surface detection.

Next, in cases in which spherical aberrations are appropriately corrected in accordance with the surface of the protective layer 40 (in other words, in cases in which the corrective action point Xc is set to “X0” or “Xmin”), the sum signal SUM and the focus error signal FE exhibit waveforms such as those shown in FIGS. 5(E) and 5(F). The sum signal SUM shown in FIG. 5(E) respectively exhibits the signal waveforms 50e, 51e, 52e when the focal point Sp passes through the surface of the protective layer 40, the second signal recording surface R1, and the first signal recording surface R0 in the stated order. The focus error signal FE shown in FIG. 5(F) respectively exhibits the S-shaped signal waveforms 50f, 51f, 52f when the focal point Sp passes through the surface of the protective layer 40, the second signal recording surface R1, and the first signal recording surface R0 in the stated order. When the focal point Sp of the light beams passes through the surface of the protective layer 40, the signal waveforms 50e, 50f having comparatively large amplitudes are exhibited, in comparison with the signal waveforms 50a through 50d in FIGS. 5(A) through 5(D).

In the present embodiment, in order to detect the surface of the protective layer 40, the aberration correction state of the liquid-crystal correction element 16 is set to the corrective action point Xs, which denotes an intermediate state between the corrective action point X0 at which spherical aberrations are appropriately corrected in accordance with the surface of the protective layer 40, and the corrective action point X1 at which spherical aberrations are appropriately corrected in accordance with the second signal recording surface R1, which is closest to the protective layer 40. The sum signal SUM and the focus error signal FE which occur in this case exhibit waveforms such as those shown in FIGS. 5(G) and 5(H), respectively. The sum signal SUM shown in FIG. 5(G) respectively exhibits the signal waveforms 50g, 51g, 52g when the focal point Sp passes through the surface of the protective layer 40, the second signal recording surface R1, and the first signal recording surface R0 in the stated order. The focus error signal FE shown in FIG. 5(H) respectively exhibits the S-shaped signal waveforms 50h, 51h, 52h when the focal point Sp passes through the surface of the protective layer 40, the second signal recording surface R1, and the first signal recording surface R0 in the stated order.

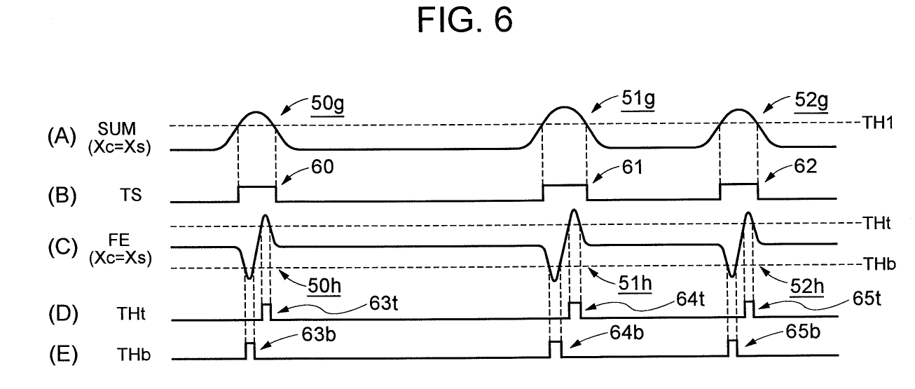

The surface detection part 35 in FIG. 1 can sequentially detect the surface of the protective layer 40, the second signal recording surface R1, and the first signal recording surface R0 on the basis of the sum signal SUM and the focus error signal FE exhibiting the waveforms shown in FIGS. 5(G) and 5(H). Specifically, as shown in FIG. 6(A), the surface detection part 35 compares the sum signal SUM with a predetermined threshold level TH1. As shown in FIG. 6(B). The surface detection part 35 outputs a high-level binarized signal TS when the level of the sum signal SUM is equal to or greater than the threshold level TH1, and outputs a low-level binarized signal TS when the level of the sum signal SUM is less than the threshold level TH1. The result is that the surface detection part 35 outputs detection pulses 60, 61, 62 indicating the detection results of the signal waveforms 50g, 51g, 52g.

The surface detection part 35 compares the focus error signal FE with a threshold level THt of positive polarity, and also compares the focus error signal FE with a threshold level THb of negative polarity, as shown in FIG. 6(C). The surface detection part 35 outputs a high-level binarized signal TFt when the level of the focus error signal FE is equal to or greater than the threshold level THt, and outputs a low-level binarized signal TFt when the level of the focus error signal FE is less than the threshold level THt, as shown in FIG. 6(D). The surface detection part 35 outputs a high-level binarized signal TFb when the level of the focus error signal FE is equal to or less than the threshold level THb, and outputs a low-level binarized signal TFb when the level of the focus error signal FE is greater than the threshold level THb, as shown in FIG. 6(E). The result is that the surface detection part 35 outputs detection pulses 63t, 64t, 65t, 63b, 64b, 65b indicating the detection results of the S-shaped signal waveforms 50h, 51h, 52h of the focus error signal FE.

In the present embodiment, the phrase “aberration correction state in which wavefront aberrations in the target surface are appropriately corrected” in the liquid-crystal correction element 16 implies a state in which, of all the aberration correction states to which the liquid-crystal correction element 16 can be set, the amplitude of the sum signal SUM or of the focus error signal FE which occurs when the focal point Sp of the light beams passes through the target surface is at a maximum. However, the state implied by the aforementioned phrase is not limited to this option alone. For example, the phrase “aberration correction state in which wavefront aberrations in the target surface are appropriately corrected” may refer to a state in which, of all the aberration correction states to which the liquid-crystal correction element 16 can be set, the jitter value or error rate of the playback RF signal is at a minimum.

The disc differentiation part 36 can differentiate the type of the optical disc 2 on the basis of the detection results of the surface detection part 35. The differentiation method is described in detail hereinbelow.

### FIRST EMBODIMENT

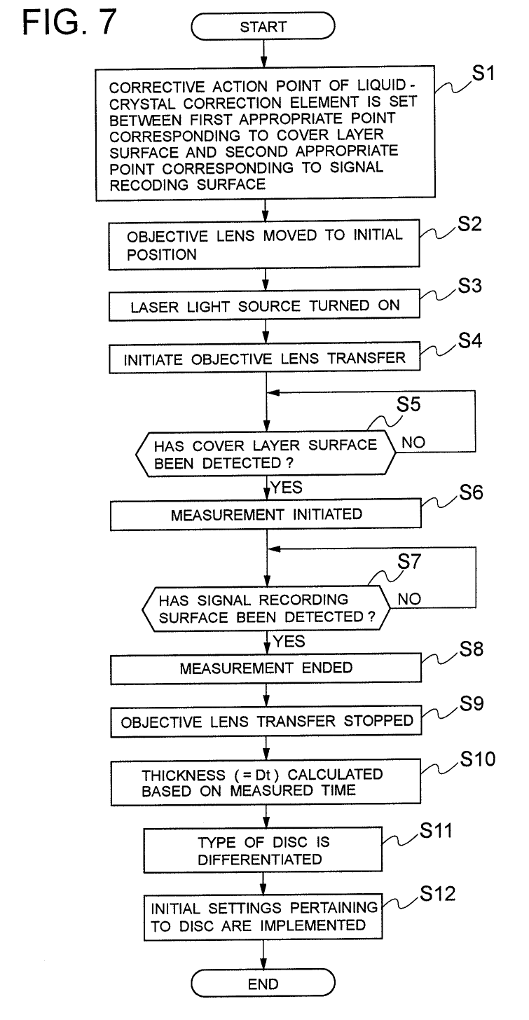

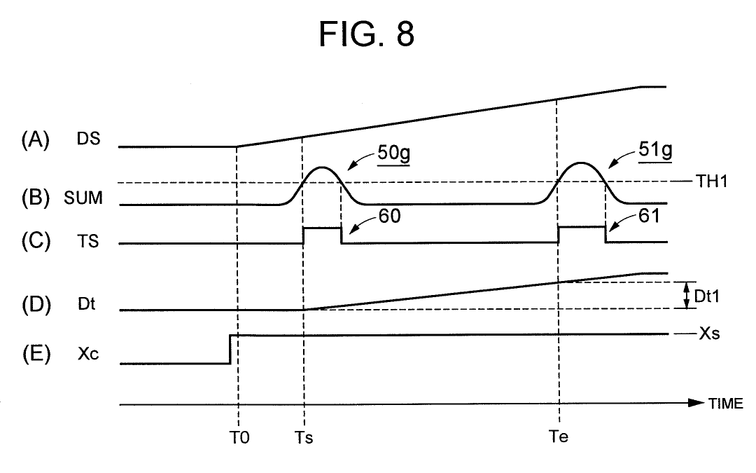

FIG. 7 is a flowchart schematically depicting the sequence of the differentiation process of the first embodiment according to the present invention. FIGS. 8(A) through 8(E) are timing charts schematically depicting the signal waveforms generated in the differentiation process of the first embodiment. FIG. 8(A) shows the waveform of the drive signal DS supplied from the controller 30 to the lens drive control part 34, FIG. 8(B) shows the waveform of the sum signal SUM, FIG. 8(C) shows the waveform of the binarized signal TS detected by the surface detection part 35, FIG. 8(D) shows the value Dt of the cover layer thickness, and FIG. 8(E) shows the corrective action point Xc of the liquid-crystal correction element 16. The process for differentiating the type of the optical disc, which is the detected object (hereinbelow referred to as the “detected disc”), is described hereinbelow with reference to FIG. 7.

In step S1, the aberration control part 32 sets the corrective action point Xc of the liquid-crystal correction element 16 to a point Xs, which is substantially intermediate between the corrective action point (first appropriate point) X0 where spherical aberrations are appropriately corrected in accordance with the surface of the protective layer 40 of an optical disc such as is shown in FIGS. 4(B) through 4(D), and the corrective action point (second appropriate point) X1 where spherical aberrations are appropriately corrected in accordance with the signal recording surface R1 of a predetermined optical disc 40. Specifically, the aberration correction state of the liquid-crystal correction element 16 is set to the corrective action point Xs corresponding to a position nearer to the surface of the protective layer 40 than the second appropriate point X1, which is set during usual recording and playback. More specifically, in compliance with a command from the controller 30, the aberration control part 32 reads a correction data set corresponding to the corrective action point Xs from the nonvolatile memory 33 and supplies to the liquid-crystal correction element 16 a drive voltage generated according to the read correction data, whereby the aberration correction state of the liquid-crystal correction element 16 is set to the action point Xs. The result is that the aberration correction state of the liquid-crystal correction element 16 is fixed at the action point Xs, as shown in FIG. 8(E). In cases in which there are physical limitations on the drive range in which the liquid-crystal correction element 16 can appropriately correct spherical aberrations, the aberration correction state of the liquid-crystal correction element 16 is set to the action point Xs between the corrective action point X1 and the lower limit Xmin of the drive range nearest to the corrective action point X0, as shown in FIG. 4(A).

Next, in step S2, the lens drive control part 34 drives the actuator 20 to move the objective lens 18 to an initial position, in accordance with the drive signal DS from the controller 30. The result is that the objective lens 18 moves to a position where the incident light beams are focused on a point farther outward than the surface of the optical disc 2, and the objective lens 18 remains in standby at this position. Next, the controller 30 drives the first light source driver 25A or the second light source driver 25B to turn on the first laser light source 11A or the second laser light source 11B (step S3). Which of the first laser light source 11A or the second laser light source 11B is turned on depends on the type of the “predetermined optical disc” assumed in order to set the appropriate point Xs in step S1 described above.

Next, in step S4, the controller 30 supplies the drive signal DS whose level steadily increases as shown in FIG. 8(A), thus initiating the transfer of the objective lens 18 from the initial position toward the optical disc 2 (time T0). At this time, the lens drive control part 34 generates a drive electric current on the basis of the drive signal DS from the controller 30 and supplies this drive electric current to the actuator 20, thereby causing the objective lens 18 to be transferred at a constant speed. The actuator 20 is driven at a frequency range lower than the resonant frequency, which is the actuator's own characteristic frequency, and the objective lens 18 is transferred at a comparatively low speed. Therefore, the level of the drive signal DS shown in FIG. 8(A) is substantially proportional to the position of the objective lens 18 along the optical axis.

When the objective lens 18 thereafter passes the focal position in relation to the surface of the cover layer of the detected disc; i.e., when the focal point Sp of the light beams passes the surface of the cover layer, the sum signal SUM exhibits the waveform 50g as shown in FIG. 8(B). The surface detection part 35 generates a signal TS resulting from binarizing the sum signal SUM as shown in FIG. 8(C), and the surface detection part 35 then detects the signal waveform 50g and outputs a detection pulse 60 to the disc differentiation part 36 (time Ts). According to the rising edge of the detection pulse 60 from the surface detection part 35, the disc differentiation part 36 determines that the surface of the cover layer of the detected disc has been detected (step S5), and uses an internal counter (not shown) to initiate measurement of the elapsed time (step S6).

When the objective lens 18 thereafter passes the focal position in relation to the signal recording surface of the detected disc; i.e., when the focal point Sp of the light beams passes the surface of the signal recording surface, the sum signal SUM exhibits the waveform 50g as shown in FIG. 8(B). The surface detection part 35 detects the signal waveform 50g and outputs a detection pulse 61 to the disc differentiation part 36 (time Te). According to the rising edge of the detection pulse 61 from the surface detection part 35, the disc differentiation part 36 determines that the signal recording surface of the detected disc has been detected (step S7), and stops measurement of the elapsed time (step S8). Immediately afterward, the controller 30 stops the transfer of the objective lens 18 (step S9).

In the next step S10, the disc differentiation part 36 calculates the thickness (=Dt) of the cover layer covering the signal recording surface of the detected disc, on the basis of the measured time. Since the objective lens 18 is transferred at a constant speed, a value (=Dt1) proportional to the measured time (=Te−Ts) is calculated as the thickness Dt of the cover layer as shown in FIG. 8(D). The disc differentiation part 36 then differentiates the type of the detected disc corresponding to the calculated cover layer thickness Dt1 (step S11), and notifies the controller 30 of the differentiation results.

The controller 30 then executes initial settings pertaining to the optical disc whose type has been differentiated (step S12). Specifically, electrical adjustments to the recording/playback device 1, settings for the aberration correction state of the liquid-crystal correction element 16, and other such settings are executed in order to enable favorable recording and playback characteristics. The differentiation process is thus ended.

In the differentiation method of the first embodiment as described above, when the focal point of the light beams directed onto the detected disc moves from the initial position toward the signal recording surface, the aberration control part 32 sets the aberration correction state (corrective action point Xc) of the liquid-crystal correction element 16 to a substantially intermediate state (Xc=Xs) between the first aberration correction state (Xc=X0 or Xmin) in which wavefront aberrations are appropriately corrected in accordance with the surface of the cover layer of a predetermined optical disc 2, and a second aberration correction state (Xc=X1) in which wavefront aberrations are appropriately corrected in accordance with the signal recording surface of the cover layer of the predetermined optical disc 2; and the cover layer surface can therefore be reliably detected even in cases in which the optical reflectivity of the cover layer surface of the detected disc is less than that of the signal recording surface. Therefore, it is possible to differentiate the type of the detected disc with a high degree of precision.

In the recording/playback device 1 shown in FIG. 1, through the function of the selective filter 18A, a high numerical aperture (hereinbelow referred to as “high NA”) is set when the second laser light source 11B, which is a short wavelength light source, is turned on, and a low numerical aperture (hereinbelow referred to as “low NA”) is set when the first laser light source 11A, which is a long wavelength light source, is turned on. Consequently, in step S1 of the disc differentiation process described above, a corrective action point suited to an optical disc corresponding to the low NA can be used, or, a corrective action point suited to an optical disc corresponding to the high NA can be used, as the corrective action point Xs between the first appropriate point X0 and the second appropriate point X1. However, since the cover layer is thin in an optical disc corresponding to a high NA used for a BD, for example, if a corrective action point Xs suited to an optical disc corresponding to the high NA is set in step S1, when a detected disc having a comparatively thick cover layer corresponding to the low NA is mounted, there is a risk that the objective lens 18 will come in contact with the cover layer surface before the focal point of the light beams reaches the signal recording surface of the detected disc, making it impossible to physically detect the signal recording surface; or that the objective lens 18 will collide with the cover layer surface.

Therefore, the “predetermined optical disc,” which is assumed in order to set the corrective action point Xs in step S1, is preferably an optical disc having a comparatively thick cover layer corresponding to the low NA. As described above, the larger the thickness of the cover layer, the greater the rate of occurrence of spherical aberrations. If the aberration correction state of the liquid-crystal correction element 16 is set to a corrective action point corresponding to either the signal recording surface or the proximity thereof, when a detected disc having a comparatively thick cover layer corresponding to the low NA is mounted, the effects of the spherical aberrations make it difficult to detect the surface of the cover layer. However, in step S1 in the embodiment described above, since the aberration correction state of the liquid-crystal correction element 16 is set between the first appropriate point X0 corresponding to the cover layer surface and the second appropriate point X1 corresponding to the signal recording surface, both the cover layer surface and the signal recording surface can be detected with a high probability, and the type [of the optical disc] can be differentiated with a high degree of precision.

In the first embodiment described above, the surface detection part 35 detects the cover layer surface and signal recording surface of the detected disc on the basis of the sum signal SUM and the disc differentiation part 36 differentiates the type of the detected disc on the basis of the binarized signal TS indicating the detection results. Instead of this option, another possibility is for the surface detection part 35 to detect the cover layer surface and signal recording surface of the detected disc on the basis of the focus error signal FE, and for the disc differentiation part 36 to differentiate the type of the detected disc on the basis of the binarized signals TFt, TFb indicating the detection results. In this case, to prevent erroneous detection of the target surfaces due to the effects of noise, the disc differentiation part 36 may differentiate the type of the detected disc on the basis of a signal obtained by computing a logical AND operation with the binarized signals TFt, TFb and the binarized signal TS.

In the first step S1 in the differentiation process (FIG. 7) of the first embodiment described above, the corrective action point Xc is set to a substantially intermediate point Xs between the first appropriate point X0 and the second appropriate point X1, but the present invention is not limited to this option alone. As long as both the cover layer surface and signal recording surface of the detected disc can be reliably detected, the corrective action point Xc may be set to a point closer to the appropriate point X0 corresponding to the cover layer surface than the appropriate point X1 corresponding to the signal recording surface. In the example in FIG. 8(B), the threshold level TH1 is a constant value, but another possibility is to instead use different threshold levels when the cover layer surface is detected and when the signal recording surface is detected.

### SECOND EMBODIMENT

In the differentiation method of the first embodiment described above, the cover layer surface and one signal recording surface were detected, and the type of the optical disc was differentiated based on the detection results. Among optical discs of the same type, there are cases in which there exist single-layer optical discs including a single signal recording layer, and multilayer optical discs including a plurality of signal recording layers. The method for differentiating the type of a multilayered optical disc is described hereinbelow.

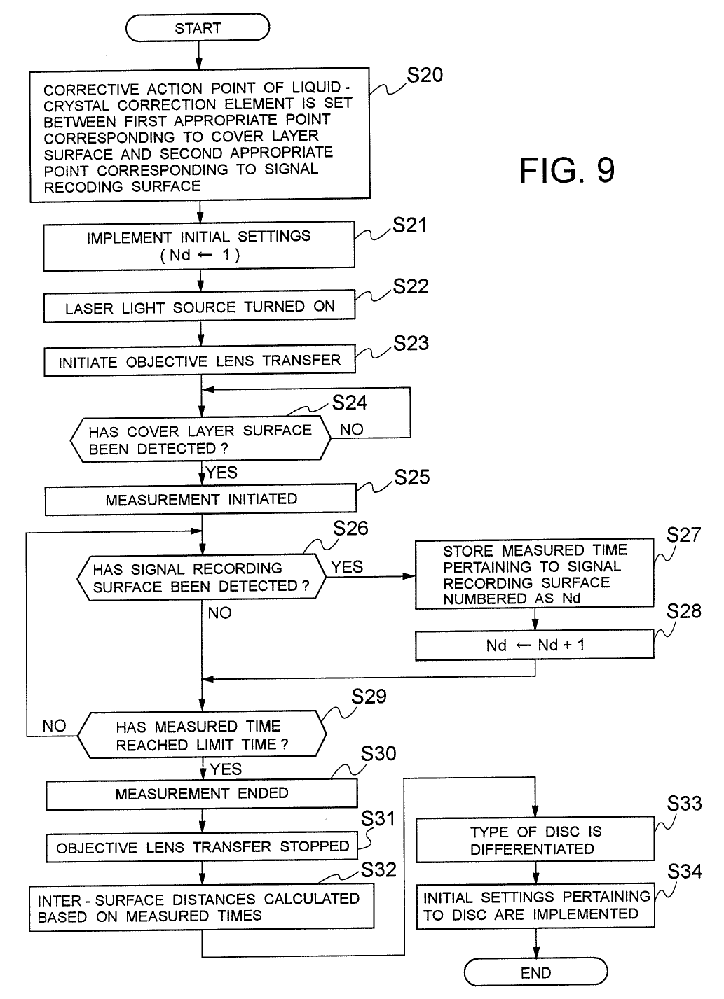

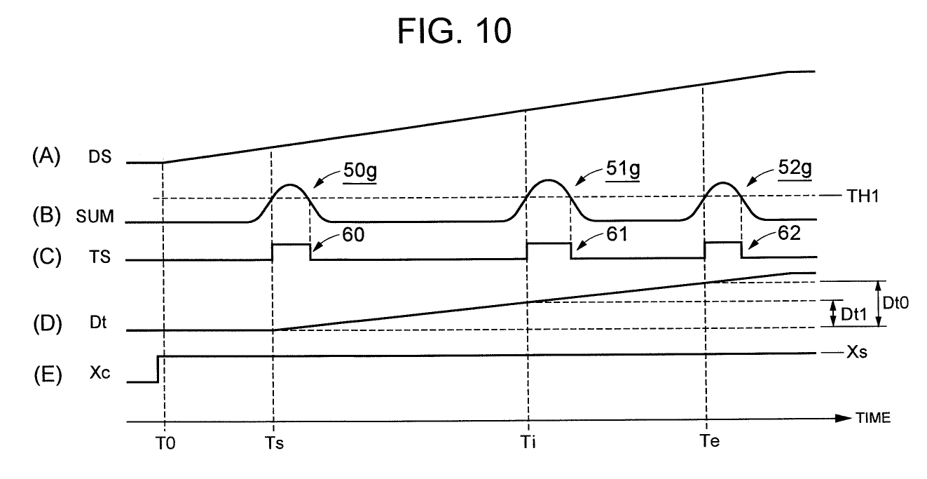

FIG. 9 is a flowchart schematically depicting the sequence of the differentiation process of the second embodiment according to the present invention. FIGS. 10(A) through 10(E) are timing charts schematically depicting the signal waveforms generated in the differentiation process of the second embodiment. FIG. 10(A) shows the waveform of the drive signal DS supplied from the controller 30 to the lens drive control part 34, FIG. 10(B) shows the waveform of the sum signal SUM, FIG. 10(C) shows the waveform of the binarized signal TS detected by the surface detection part 35, FIG. 10(D) shows the value Dt of the cover layer thickness, and FIG. 10(E) shows the corrective action point Xc of the liquid-crystal correction element 16. The process for differentiating the type of the optical disc, which is the detected object (hereinbelow referred to as the “detected disc”), is described hereinbelow with reference to FIG. 9.

In step S20, the aberration control part 32 sets the corrective action point Xc of the liquid-crystal correction element 16 to a point Xs, which is substantially intermediate between the corrective action point (first appropriate point) X0 where spherical aberrations are appropriately corrected in accordance with the surface of the protective layer 40 of a predetermined optical disc such as is shown in FIGS. 4(B) through 4(D), and the corrective action point (second appropriate point) X1 where spherical aberrations are appropriately corrected in accordance with the signal recording surface R1 of the predetermined optical disc 40. More specifically, in compliance with a command from the controller 30, the aberration control part 32 reads a correction data set corresponding to the corrective action point Xs from the nonvolatile memory 33 and supplies to the liquid-crystal correction element 16 a drive voltage generated according to the read correction data, whereby the aberration correction state of the liquid-crystal correction element 16 is set to the action point Xs. The result is that the aberration correction state of the liquid-crystal correction element 16 is fixed at the action point Xs, as shown in FIG. 10(E). In cases in which there are physical limitations on the drive range in which the liquid-crystal correction element 16 can appropriately correct spherical aberrations, the aberration correction state of the liquid-crystal correction element 16 is set to the action point Xs between the corrective action point X1 and the lower limit Xmin of the drive range nearest to the corrective action point X0, as shown in FIG. 4(A).

In step S20, similar to the first embodiment described above, to reliably prevent the objective lens 18 from coming in contact with the cover layer surface before the focal point of the light beams reaches the plurality of signal recording surfaces of the detected disc, the “predetermined optical disc” assumed in order to set the corrective action point Xs is preferably an optical disc having a comparatively thick cover layer corresponding to the low NA.

Next, in step S21, initial settings are implemented. Specifically, the disc differentiation part 36 sets the number Nd of the signal recording surface to be detected to “1.” The lens drive control part 34 transfers the objective lens 18 to an initial position via (*6) the actuator 20, in accordance with the drive signal DS from the controller 30. The result is that the objective lens 18 moves to a position where the incident light beams are focused on a point farther outward than the surface of the optical disc 2, and the objective lens 18 remains in standby at this position. Next, the controller 30 drives the light source driver 25A or 25B corresponding to the standards of the “predetermined optical disc” to turn on the laser light source 11A or 11B (step S22).

In the next step S23, the controller 30 supplies to the lens drive control part 34 the drive signal DS whose level steadily increases as shown in FIG. 10(A), thus initiating the transfer of the objective lens 18 from the initial position toward the optical disc 2 (time T0). When the objective lens 18 thereafter passes the focal position in relation to the surface of the cover layer of the detected disc; i.e., when the focal point Sp of the light beams passes the surface of the cover layer, the sum signal SUM exhibits the waveform 50g as shown in FIG. 10(B). The surface detection part 35 generates a signal TS resulting from binarizing the sum signal SUM as shown in FIG. 10(C), and the surface detection part 35 then detects the signal waveform 50g and outputs a detection pulse 60 to the disc differentiation part 36 (time Ts). According to the rising edge of the detection pulse 60 from the surface detection part 35, the disc differentiation part 36 determines that the surface of the cover layer of the detected disc has been detected (step S24), and uses an internal counter (not shown) to initiate measurement of the elapsed time (step S25).

When the objective lens 18 thereafter passes the focal position in relation to the signal recording surface of the detected disc; i.e., when the focal point Sp of the light beams passes the surface of the signal recording surface, the sum signal SUM exhibits the waveform 51g as shown in FIG. 10(B), for example. The surface detection part 35 detects the signal waveform 51g and outputs a detection pulse 61 to the disc differentiation part 36 (time Ti). According to the rising edge of the detection pulse 61 from the surface detection part 35, the disc differentiation part 36 determines that the signal recording surface of the detected disc has been detected (step S26), and a measured time (=Ti−Ts) is stored pertaining to the signal recording surface numbered as Nd (step S27).

Next, the disc differentiation part 36 increments the number Nd of the signal recording surface (step S28), and determines whether or not the measured time has reached a preset limit time (step S29). If the measured time exceeds the limit time (step S29), the disc differentiation part 36 concludes there is a risk that the objective lens 18 will come in contact or collide with the surface of the detected disc and ends the elapsed time measurement (step S30), and the controller 30 stops the transfer of the objective lens 18 (step S31).

If the disc differentiation part 36 determines that the measured time has not reached the limit time (step S29), the process sequence in step S26 is repeated. In this case, when the objective lens 18 passes a position focused at the signal recording surface of the detected disc; i.e., when the focal point Sp of the light beams passes the surface of the signal recording surface, the sum signal SUM exhibits the waveform 52g as is shown in FIG. 10(B), for example. The surface detection part 35 detects the signal waveform 52g and outputs a detection pulse 62 to the disc differentiation part 36 (time Te). According to the rising edge of the detection pulse 62 from the surface detection part 35, the disc differentiation part 36 determines that the signal recording surface of the detected disc has been detected (step S26), a measured time (=Te−Ts) is stored pertaining to the signal recording surface numbered as Nd (step S27), and the number Nd of the signal recording surface is incremented (step S28).

After the sequence of steps S26 through S28 described above is executed, when the disc differentiation part 36 has determined that the measured time has reached the limit time (step S29), measurement of the elapsed time is ended (step S30). The controller 30 then stops the transfer of the objective lens 18 (step S31).

Next, in step S32, the disc differentiation part 36 calculates the inter-surface distances of the detected disc on the basis of the measured times stored for the detected signal recording surfaces (step S32). For example, in cases in which a total of two signal recording surfaces have been detected up until the measured time reached the limit time, the disc differentiation part 36 calculates the inter-surface distance between the cover layer surface of the detected disc and the first detected signal recording surface, and also calculates the inter-surface distance between the cover layer surface and the second detected signal recording surface. Referring to an internal table (not shown), the disc differentiation part 36 then retrieves the type of optical disc having these inter-surface distances to differentiate the type of the detected disc (step S33), and notifies the controller 30 of the differentiation results. Since the objective lens 18 is transferred at a constant speed, the disc differentiation part 36 can calculate a value (=Dt1), which is proportional to the time difference (=Ti−Ts) between the detection time (=Ts) of the cover layer surface of the detected disc and the detection time (=Ti) of the first signal recording surface, as the thickness of the cover layer covering the first signal recording surface. The disc differentiation part 36 can also calculate a value (=Dt0), which is proportionate to the time difference (=Te−Ts) between the detection time (=Ts) of the cover layer surface of the detected disc and the detection time (=Te) of the second signal recording surface, as the thickness of the cover layer covering the second signal recording surface.

The controller 30 then implements initial settings pertaining to the optical disc whose type has been differentiated (step S34). Specifically, electrical adjustments to the recording/playback device 1, settings for the aberration correction state of the liquid-crystal correction element 16, and other such settings are implemented in order enable favorable recording and playback characteristics. The differentiation process is thus ended.

In the differentiation method of the second embodiment as described above, when the focal point of the light beams directed onto the detected disc moves from the initial position toward the signal recording surface, the aberration control part 32 sets the aberration correction state (corrective action point Xc) of the liquid-crystal correction element 16 to a substantially intermediate state (Xc=Xs) between the first aberration correction state (Xc=X0 or Xmin) in which wavefront aberrations are appropriately corrected in accordance with the surface of the cover layer of a predetermined optical disc, and a second aberration correction state (Xc=X1) in which wavefront aberrations are appropriately corrected in accordance with the signal recording surface of the cover layer of the predetermined optical disc; and the cover layer surface can therefore be reliably detected even in cases in which the optical reflectivity of the cover layer surface of the detected disc is less than that of the signal recording surface. Therefore, it is possible to accurately detect the distances between the cover layer surface and each of a plurality of signal recording surfaces of the detected disc, and it is therefore possible to differentiate the type of a multilayer detected disc and not just the type of single-layer detected disk with a high degree of precision.

As with the first embodiment described above, the surface detection part 35 may use the focus error signal FE instead of the sum signal SUM to detect the cover layer surface and a plurality of signal recording surfaces of the detected disc. In step S20 described above, the action corrective point Xc (*8) is set to a substantially intermediate point Xs between the first appropriate point X0 and the second appropriate point X1, but another alternative is to instead set a corrective action point Xc to a point closer to the appropriate point X0 corresponding to the cover layer surface than the appropriate point X1 corresponding to the signal recording surface. Furthermore, in the example in FIG. 10(B), the threshold level TH1 is a constant value, but another possibility is to instead use different threshold levels when the cover layer surface is detected and when the signal recording surfaces are detected.

### THIRD EMBODIMENT

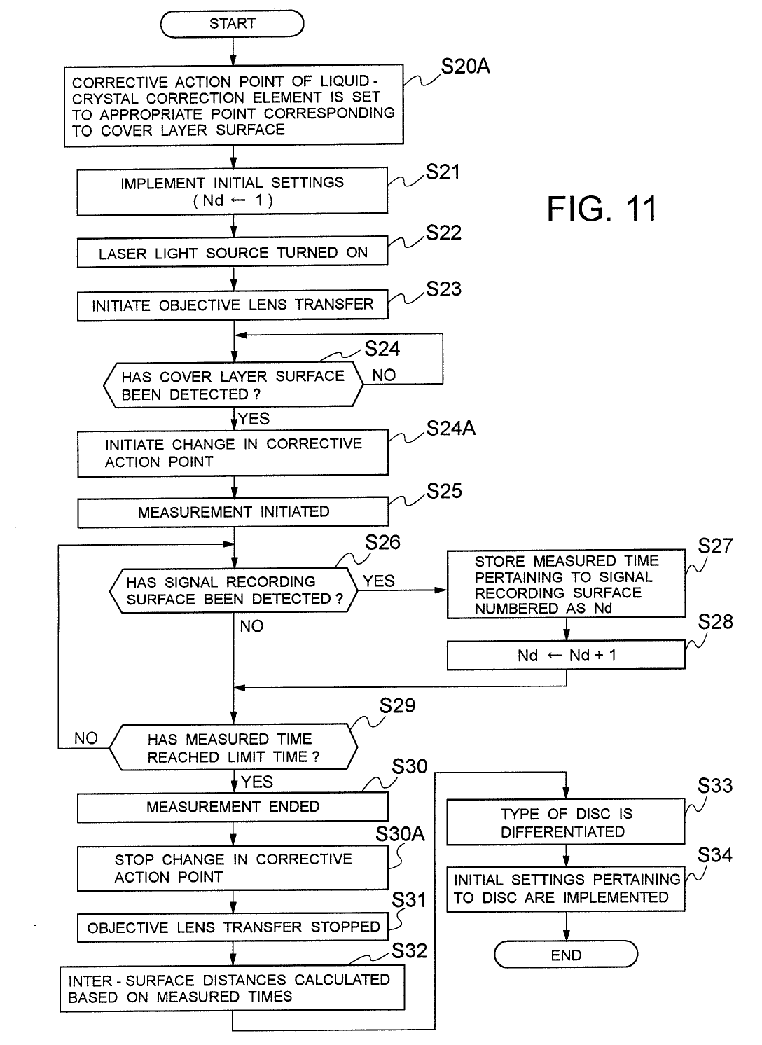

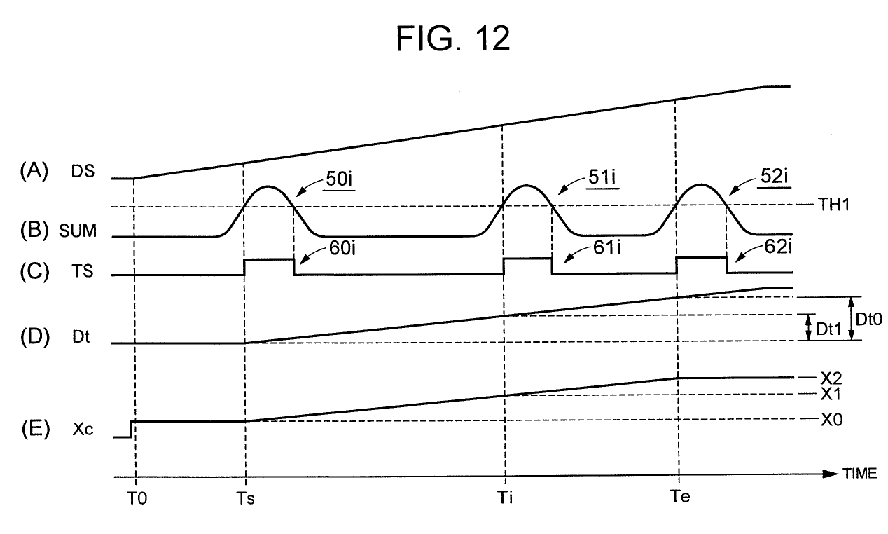

Next, the third embodiment according to the present invention will be described. FIG. 11 is a flowchart schematically depicting the sequence of the differentiation process of the third embodiment. FIGS. 12(A) through 12(E) are timing charts schematically depicting the signal waveforms generated in the differentiation process of the third embodiment. FIG. 12(A) shows the waveform of the drive signal DS supplied from the controller 30 to the lens drive control part 34, FIG. 12(B) shows the waveform of the sum signal SUM, FIG. 12(C) shows the waveform of the binarized signal TS detected by the surface detection part 35, FIG. 12(D) shows the value Dt of the cover layer thickness, and FIG. 12(E) shows the corrective action point Xc of the liquid-crystal correction element 16. In the flowchart in FIG. 11, a process sequence using the same step numbers as the step numbers of the flowchart in FIG. 9 described above is the same as the sequence of the differentiation process of the second embodiment described above, and detailed descriptions thereof are omitted. The process for differentiating the type of the optical disc, which is the detected object (hereinbelow referred to as the “detected disc”), is described hereinbelow with reference to FIG. 11.

In step S20A, the aberration control part 32 sets the corrective action point Xc of the liquid-crystal correction element 16 to a corrective action point (first appropriate point) X0 where spherical aberrations are appropriately corrected in accordance with the surface of the protective layer 40 of a predetermined optical disc such as is shown in FIGS. 4(B) through 4(D). The result is that the aberration correction state of the liquid-crystal correction element 16 is fixed at the action point X0 as shown in FIG. 12(E). In cases in which there are physical limitations on the drive range in which the liquid-crystal correction element 16 can appropriately correct spherical aberrations, the aberration correction state of the liquid-crystal correction element 16 is set to the lower limit Xmin of the drive range nearest to the corrective action point X0, as shown in FIG. 4(A).

In step S20A, similar to the first embodiment described above, to reliably prevent the objective lens 18 from coming in contact with the cover layer surface before the focal point of the light beams reaches the plurality of signal recording surfaces of the detected disc, the “predetermined optical disc” assumed in order to set the corrective action point Xs is preferably an optical disc having a comparatively thick cover layer corresponding to the low NA.

In the next step S21, initial settings are implemented. Specifically, the disc differentiation part 36 sets the number Nd of the signal recording surface to be detected to “1.” The lens drive control part 34 transfers the objective lens 18 to an initial position via (*6) the actuator 20, in accordance with the drive signal DS from the controller 30. Next, the controller 30 drives the light source driver 25A or 25B corresponding to the standards of the “predetermined optical disc” to turn on the laser light source 11A or 11B (step S22).

In the next step S23, the controller 30 supplies to the lens drive control part 34 the drive signal DS whose level steadily increases as shown in FIG. 12(A), thus initiating the transfer of the objective lens 18 (time T0). When the objective lens 18 thereafter passes the focal position in relation to the surface of the cover layer of the detected disc; i.e., when the focal point Sp of the light beams passes the surface of the cover layer, the sum signal SUM exhibits the waveform 50i as shown in FIG. 12(B). The surface detection part 35 generates a detection pulse 60i in accordance with the signal waveform 50i as shown in FIG. 12(C), and outputs the detection pulse 60i to the disc differentiation part 36 (time Ts). According to the rising edge of the detection pulse 60i from the surface detection part 35, the disc differentiation part 36 determines that the surface of the cover layer of the detected disc has been detected (step S24), and notifies the controller 30 of the determination results.

In the next step S24A, the controller 30 initiates a change in the corrective action point Xc of the liquid-crystal correction element 16 (time Ts), in accordance with the determination results from the disc differentiation part 36. The disc differentiation part 36 also uses an internal counter (not shown) to initiate measurement of the elapsed time (step S25). Hereinafter, the aberration correction state of the liquid-crystal correction element 16 gradually changes over time from the initial action point X0 toward the target action point X1 or toward an action point in the vicinity thereof.

The target action point X1 is preferably the second appropriate point X1 in which spherical aberrations are appropriately corrected in accordance with the signal recording surface of the “predetermined optical disc” described above.

When the objective lens 18 thereafter passes the focal position in relation to the signal recording surface of the detected disc; i.e., when the focal point Sp of the light beams passes the surface of the signal recording surface, the sum signal SUM exhibits the waveform 51i as shown in FIG. 12(B), for example. The surface detection part 35 detects the signal waveform 51i and outputs a detection pulse 61i to the disc differentiation part 36 (time Ti). According to the rising edge of the detection pulse 61i from the surface detection part 35, the disc differentiation part 36 determines that the signal recording surface of the detected disc has been detected (step S26), and stores a measured time (=Ti−Ts) pertaining to the signal recording surface numbered as Nd (step S27).

The aberration correction state of the liquid-crystal correction element 16 is controlled so as to continue changing over time, even after reaching the second appropriate point X1 or a point in the vicinity thereof, as shown in FIG. 12(E).

Next, the disc differentiation part 36 increments the number Nd of the signal recording surface (step S28), and determines whether or not the measured time has reached a preset limit time (step S29). If the measured time exceeds the limit time (step S29), the disc differentiation part 36 ends the elapsed time measurement (step S30), and the controller 30 stops the transfer of the objective lens 18 (step S31).

If the disc differentiation part 36 determines that the measured time has not reached the limit time (step S29), the process sequence in step S26 is repeated. In this case, when the objective lens 18 passes a position focused at the signal recording surface of the detected disc; i.e., when the focal point Sp of the light beams passes the surface of the signal recording surface, the sum signal SUM exhibits the waveform 52i as is shown in FIG. 12(B), for example. The surface detection part 35 detects the signal waveform 52i and outputs a detection pulse 62i to the disc differentiation part 36 (time Te). According to the rising edge of the detection pulse 62i from the surface detection part 35, the disc differentiation part 36 determines that the signal recording surface of the detected disc has been detected (step S26), a measured time (=Te−Ts) is stored pertaining to the signal recording surface numbered as Nd (step S27), and the number Nd of the signal recording surface is incremented (step S28).

After the sequence of steps S26 through S28 described above is executed, when the disc differentiation part 36 has determined that the measured time has reached the limit time (step S29), measurement of the elapsed time is ended (step S30). The controller 30 then stops the change in the aberration correction state of the liquid-crystal correction element 16 (step S30A) and stops the transfer of the objective lens 18 (step S31). The result is that the aberration correction state of the liquid-crystal correction element 16 reaches a third appropriate point X2, as exemplified in FIG. 12(E).

In the next step S32, the disc differentiation part 36 calculates the inter-surface distances of the detected disc on the basis of the stored measured times (step S32). Referring to an internal table (not shown), the disc differentiation part 36 then retrieves the type of optical disc having these inter-surface distances to differentiate the type of the detected disc (step S33), and notifies the controller 30 of the differentiation results. The controller 30 then implements initial settings pertaining to the optical disc whose type has been differentiated (step S34). The differentiation process is thus ended.

In the differentiation method of the third embodiment as described above, when the focal point of the light beams directed onto the detected disc begin to move from the initial position toward the signal recording surface, the aberration control part 32 sets the aberration correction state (corrective action point Xc) of the liquid-crystal correction element 16 to a first aberration correction state (Xc=X0 or Xmin) in which wavefront aberrations are appropriately corrected in accordance with the surface of the cover layer of a predetermined optical disc. Therefore, the waveform of the sum signal SUM which occurs when the focal point of the light beams passes the surface of the cover layer has a large amplitude, and the waveform can be reliably detected.

After the surface of the cover layer of the detected disc is detected, the aberration control part 32 gradually changes the aberration correction state (corrective action point Xc) of the liquid-crystal correction element 16 from the first aberration correction state toward the second aberration correction state in which spherical aberrations are appropriately corrected in accordance with the signal recording surface of a predetermined optical disc, the change being synchronous with the movement of the focal point of the light beams. Therefore, the waveform of the sum signal SUM which occurs when the focal point of the light beams passes the signal recording surface has a large amplitude, and the waveform can be easily detected.

Therefore, it is possible to accurately calculate either the thickness of the cover layer covering the signal recording surface of the detected disc or a value equivalent to the thickness, and it is possible to differentiate the type of the detected disc with a high degree of precision.

Similar to the first embodiment described above, the surface detection part 35 may use the focus error signal FE instead of the sum signal SUM to detect the cover layer surface and a plurality of signal recording surfaces of the detected disc. In the example in FIG. 12(B), the threshold level TH1 is a constant value, but another possibility is to instead use different threshold levels when the cover layer surface is detected and when the signal recording surfaces are detected.

### Modification of Third Embodiment

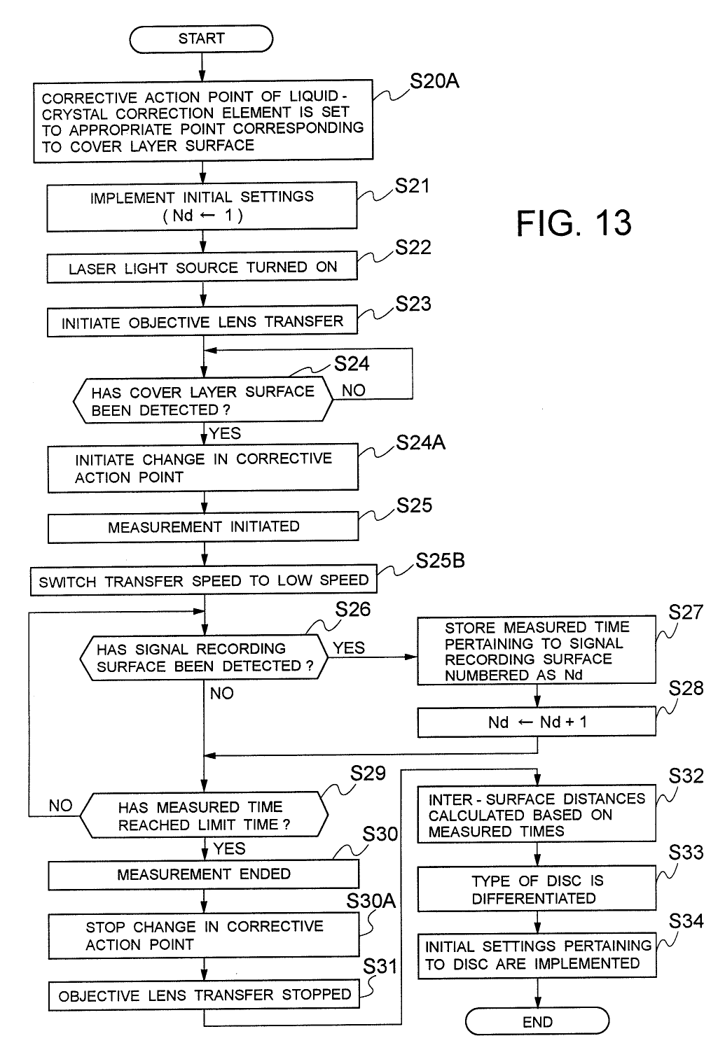

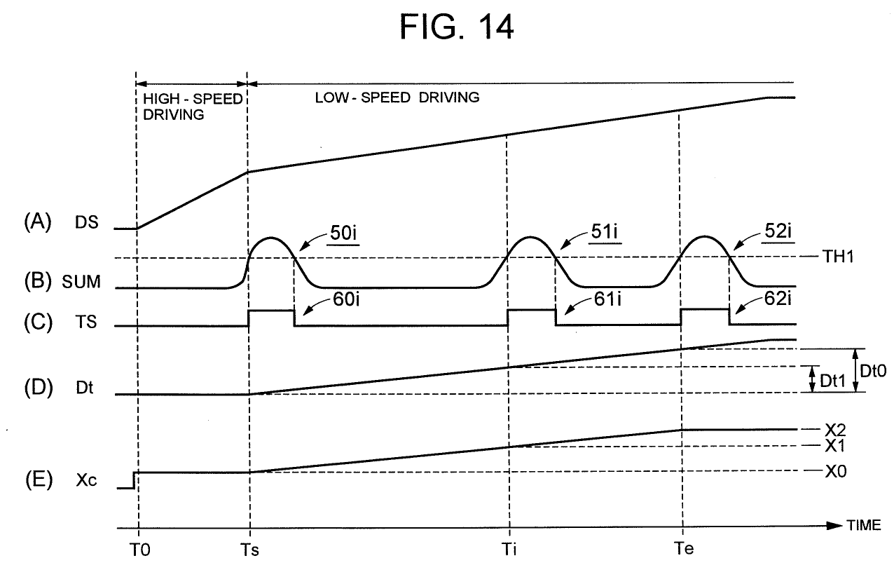

Next, a modification of the above-described third embodiment will be described. FIG. 13 is a flowchart schematically depicting the sequence of the differentiation process of the present modification. FIGS. 14(A) through 14(E) are timing charts schematically depicting the signal waveforms generated in the differentiation process of the present modification. FIG. 14(A) shows the waveform of the drive signal DS supplied from the controller 30 to the lens drive control part 34, FIG. 14(B) shows the waveform of the sum signal SUM, FIG. 14(C) shows the waveform of the binarized signal TS detected by the surface detection part 35, FIG. 14(D) shows the value Dt of the cover layer thickness, and FIG. 14(E) shows the corrective action point Xc of the liquid-crystal correction element 16. In the flowchart in FIG. 13, a process sequence using the same step numbers as the step numbers of the flowchart in FIG. 11 described above is the same as the sequence of the differentiation process of the second embodiment described above, and detailed descriptions thereof are omitted.

Referring to FIG. 13, the same steps S20A, S21, S22, S23, S24, S24A, S25 as those of the sequence of the above-described third embodiment (FIG. 11) are executed in the stated order. However, in step S23, the controller 30 supplies the drive signal DS to the lens drive control part 34 so that the transfer speed of the objective lens 18; i.e., the movement speed of the focal point of the light beams is comparatively high. The result is that the rate of increase of the level of the drive signal DS as exemplified in FIG. 14(A) is greater than the rate of increase of the level of the drive signal DS shown in FIG. 12(A).

After the disc differentiation part 36 initiates measurement of the elapsed time in step S25, the controller 30 supplies a drive signal DS to the lens drive control part 34 to switch the movement speed so that the transfer speed of the objective lens 18; i.e., the movement speed of the focal point of the light beams will be low (step S25B). Thereafter, steps S26 through S34 identical to those in the sequence of the above-described third embodiment (FIG. 11) are executed in the stated order.

As described above, the transfer speed of the objective lens 18; i.e., the movement speed of the focal point of the light beams is set to be comparatively high until the surface of the cover layer of the detected disc is detected, and after the surface of the cover layer is detected, the transfer speed of the objective lens 18; i.e., the movement speed of the focal point of the light beams is switched from a high speed to a low speed. Therefore, it is possible to shorten the time needed to differentiate the type of the detected disc while avoiding collisions between the objective lens 18 and the detected disc.

1. An optical recording/playback device for recording information onto an optical recording medium having at least one signal recording surface covered by a cover layer, or for playing back said recorded information from said optical recording medium; the optical recording/playback device characterized in comprising:
a light source for emitting a light beam to be directed onto an optical recording medium that is an object to be detected;
an objective lens for focusing the light beam from said light source;
a lens drive part for moving the focal point of the light beam directed from said objective lens from a predetermined position outside of the surface of said cover layer toward said signal recording surface;
a photodetector for detecting a returning light beam reflected by said optical recording medium;
a detection part for sequentially detecting the surface of the cover layer and one or a plurality of signal recording surfaces of said optical recording medium on the basis of an output signal of said photodetector when the focal point of said light beam moves from said predetermined position toward said signal recording surface;
a medium differentiation part for differentiating the type of said optical recording medium on the basis of the detection results of said detection part;
an aberration correction element for modulating a phase of the light beam to be directed onto said optical recording medium and for correcting wavefront aberrations; and
an aberration control part for controlling an aberration correction state of said aberration correction element; wherein
when said lens drive part moves the focal point of said light beam from said predetermined position toward said signal recording surface, said aberration control part sets the aberration correction state of said aberration correction element to a state between a first aberration correction state in which said wavefront aberrations are corrected in accordance with a surface of a cover layer of a predetermined optical recording medium, and a second aberration correction state in which said wavefront aberrations are corrected in accordance with a signal recording surface of said predetermined optical recording medium.

2. An optical recording/playback device for recording information onto an optical recording medium having at least one signal recording surface covered by a cover layer, or for playing back said recorded information from said optical recording medium; the optical recording/playback device characterized in comprising:
a light source for emitting a light beam to be directed onto an optical recording medium that is an object to be detected;
an objective lens for focusing the light beam from said light source;
a lens drive part for moving the focal point of the light beam directed from said objective lens from a predetermined position outside of the surface of said cover layer toward said signal recording surface;
a photodetector for detecting a returning light beam reflected by said optical recording medium;
a detection part for sequentially detecting the surface of the cover layer and one or a plurality of signal recording surfaces of said optical recording medium on the basis of an output signal of said photodetector when the focal point of said light beam moves from said predetermined position toward said signal recording surface;
a medium differentiation part for differentiating the type of said optical recording medium on the basis of the detection results of said detection part;
an aberration correction element for modulating a phase of the light beam to be directed onto said optical recording medium and for correcting wavefront aberrations; and
an aberration control part for controlling an aberration correction state of said aberration correction element; wherein
when said lens drive part initiates movement of the focal point of said light beam from said predetermined position toward said signal recording surface, said aberration control part sets the aberration correction state of said aberration correction element to a first aberration correction state in which said wavefront aberrations are corrected in accordance with a surface of a cover layer of a predetermined optical recording medium; and
after said detection part has detected the surface of the cover layer of said detected object, said aberration control part gradually changes the aberration correction state of said aberration correction element from said first aberration correction state toward a second aberration correction state in which said wavefront aberrations are corrected in accordance with a signal recording surface of said predetermined optical recording medium, in synchronization with the movement of the focal point of said light beam.

3. The optical recording/playback device of claim 1, characterized in that said medium differentiation part measures the time difference from detection of the surface of said cover layer until the detection of said signal recording surface, and differentiates the type of the optical recording medium corresponding to the thickness of said cover layer on the basis of said measured time difference.

4. The optical recording/playback device of claim 1, characterized in that said detection part comprises:
a signal generator for generating a sum signal indicating the total amount of light received from said returning light beam on the basis of an output signal of said photodetector; and
a surface detection part for comparing the level of said sum signal with a threshold level, and for sequentially detecting the surface of said cover layer and one or a plurality of signal recording surfaces on the basis of the results of said comparison.

5. The optical recording/playback device according to claim 1, characterized in that said detection part comprises:
a signal generator for generating a focus error signal for a focus servo on the basis of an output signal of said photodetector; and
a surface detection part for comparing the level of said focus error signal with a threshold level, and for sequentially detecting the surface of said cover layer and one or a plurality of signal recording surfaces on the basis of the results of said comparison.

6. The optical recording/playback device of claim 4, characterized in that said first aberration correction state is, among the aberration correction states to which said aberration correction element can be set, a state in which the amplitude of said sum signal occurring when the focal point of said light beam passes the surface of said cover layer is maximized; and said second aberration correction state is, among the aberration correction states to which said aberration correction element can be set, a state in which the amplitude of said sum signal occurring when the focal point of said light beam reaches said signal recording surface is maximized.

7. The optical recording/playback device of claim 5, characterized in that said first aberration correction state is, among the aberration correction states to which said aberration correction element can be set, a state in which the amplitude of said focus error signal occurring when the focal point of said light beam passes the surface of said cover layer is maximized; and said second aberration correction state is, among the aberration correction states to which said aberration correction element can be set, a state in which the amplitude of said focus error signal occurring when the focal point of said light beam reaches said signal recording surface is maximized.

8. The optical recording/playback device of claim 1, characterized in that said second aberration correction state is, among the aberration correction states to which said aberration correction element can be set, a state in which the jitter value or error rate of said playback signal occurring when the focal point of said light beam reaches said signal recording surface is minimized.

9. The optical recording/playback device of claim 1, characterized in that:
said aberration correction element is a liquid-crystal optical element having two mutually opposing electrode layers, and a birefringent liquid-crystal layer enclosed between the electrode layers; and
said aberration control part sets said aberration correction state by applying a drive voltage to each of said electrode layers.

10. The optical recording/playback device of claim 9, further comprising memory for storing a plurality of correction data sets corresponding respectively to the plurality of aberration correction states; the optical recording/playback device characterized in that:
said aberration control part selectively reads any of said correction data sets from said memory and generates said drive voltages in accordance with said read correction data sets.

11. The optical recording/playback device of claim 1, characterized in that said wavefront aberrations are spherical aberrations which occur as a result of errors in the thickness of said cover layer.

12. The optical recording/playback device of claim 1, characterized in that said lens drive part moves the focal point of said light beam at a first speed before said detection part detects the surface of said cover layer, and moves the focal point of said light beam at a second speed lower than said first speed after said detection part has detected the surface of said cover layer.

13. A medium differentiation method for differentiating a type of an object to be detected in an optical recording/playback device comprising a light source for emitting a light beam to be directed onto an optical recording medium as said detected object having at least one signal recording surface covered by a cover layer, an objective lens for focusing the light beam from said light source, a lens drive part for moving the focal point of the light beam directed from said objective lens from a predetermined position outside of the surface of said cover layer toward said signal recording surface, a photodetector for detecting a returning light beam reflected by said detected object, and an aberration correction element for modulating a phase of the light beam to be directed onto said detected object and for correcting wavefront aberrations; the medium differentiation method characterized in comprising:
(a) a step for setting the aberration correction state of said aberration correction element to a state between a first aberration correction state in which said wavefront aberrations are corrected in accordance with a surface of a cover layer of a predetermined optical recording medium, and a second aberration correction state in which said wavefront aberrations are corrected in accordance with a signal recording surface of said predetermined optical recording medium, when said lens drive part moves the focal point of said light beam from said predetermined position toward said signal recording surface;
(b) a step for sequentially detecting the surface of the cover layer and one or a plurality of signal recording surfaces of said detected object on the basis of an output signal of said photodetector, when said lens drive part moves the focal point of said light beam from said predetermined position toward said signal recording surface; and
(c) a step for differentiating the type of said detected object on the basis of the detection results of said step (b).

14. The medium differentiation method of claim 13, characterized in that said step (c) includes a step for measuring a time difference from detection of the surface of said cover layer until detection of said signal recording surface, and for differentiating the type of the optical recording medium corresponding to the thickness of said cover layer on the basis of said measured time difference.

15. A medium differentiation method for differentiating the type of an object to be detected in an optical recording/playback device comprising a light source for emitting a light beam to be directed onto an optical recording medium as said detected object having at least one signal recording surface covered by a cover layer, an objective lens for focusing the light beam from said light source, a lens drive part for moving the focal point of the light beam directed from said objective lens from a predetermined position outside of the surface of said cover layer toward said signal recording surface, a photodetector for detecting a returning light beam reflected by said optical recording medium, and an aberration correction element for modulating a phase of the light beam to be directed onto said optical recording medium and for correcting wavefront aberrations; the medium differentiation method characterized in comprising:
(a) a step for setting the aberration correction state of said aberration correction element to a first aberration correction state in which said wavefront aberrations are corrected in accordance with a surface of a cover layer of a predetermined optical recording medium when said lens drive part initiates movement of the focal point of said light beam from said predetermined position toward said signal recording surface;
(b) a step for detecting the surface of the cover layer of said detected object on the basis of an output signal of said photodetector when said lens drive part moves the focal point of said light beam from said predetermined position toward said signal recording surface;
(c) a step for gradually changing the aberration correction state of said aberration correction element from said first aberration correction state toward a second aberration correction state in which said wavefront aberrations are corrected in accordance with a signal recording surface of said predetermined optical recording medium, in synchronization with movement of the focal point of said light beam, after the surface of said cover layer has been detected in said step (b);
(d) a step for detecting one or a plurality of signal recording surfaces of said detected object on the basis of an output signal of said photodetector when said lens drive part moves the focal point of said light beam from the surface of said cover layer toward said signal recording surface; and
(e) a step for differentiating the type of said detected object on the basis of the detection results of said steps (b) and (d).

16. The medium differentiation method of claim 15, characterized in that said step (e) includes a step for measuring a time difference from detection of the surface of said cover layer until detection of said signal recording surface, and for differentiating the type of the optical recording medium corresponding to the thickness of said cover layer on the basis of said measured time difference.

17. The optical recording/playback device of claim 2, characterized in that said medium differentiation part measures the time difference from detection of the surface of said cover layer until the detection of said signal recording surface, and differentiates the type of the optical recording medium corresponding to the thickness of said cover layer on the basis of said measured time difference.

18. The optical recording/playback device of claim 2, characterized in that said detection part comprises:
a signal generator for generating a sum signal indicating the total amount of light received from said returning light beam on the basis of an output signal of said photodetector; and
a surface detection part for comparing the level of said sum signal with a threshold level, and for sequentially detecting the surface of said cover layer and one or a plurality of signal recording surfaces on the basis of the results of said comparison.

19. The optical recording/playback device according to claim 2, characterized in that said detection part comprises:
a signal generator for generating a focus error signal for a focus servo on the basis of an output signal of said photodetector; and
a surface detection part for comparing the level of said focus error signal with a threshold level, and for sequentially detecting the surface of said cover layer and one or a plurality of signal recording surfaces on the basis of the results of said comparison.

20. The optical recording/playback device of claim 18, characterized in that said first aberration correction state is, among the aberration correction states to which said aberration correction element can be set, a state in which the amplitude of said sum signal occurring when the focal point of said light beam passes the surface of said cover layer is maximized; and said second aberration correction state is, among the aberration correction states to which said aberration correction element can be set, a state in which the amplitude of said sum signal occurring when the focal point of said light beam reaches said signal recording surface is maximized.

21. The optical recording/playback device of claim 19, characterized in that said first aberration correction state is, among the aberration correction states to which said aberration correction element can be set, a state in which the amplitude of said focus error signal occurring when the focal point of said light beam passes the surface of said cover layer is maximized; and said second aberration correction state is, among the aberration correction states to which said aberration correction element can be set, a state in which the amplitude of said focus error signal occurring when the focal point of said light beam reaches said signal recording surface is maximized.

22. The optical recording/playback device of claim 2, characterized in that said second aberration correction state is, among the aberration correction states to which said aberration correction element can be set, a state in which the jitter value or error rate of said playback signal occurring when the focal point of said light beam reaches said signal recording surface is minimized.

23. The optical recording/playback device of claim 2, characterized in that:
said aberration correction element is a liquid-crystal optical element having two mutually opposing electrode layers, and a birefringent liquid-crystal layer enclosed between the electrode layers; and
said aberration control part sets said aberration correction state by applying a drive voltage to each of said electrode layers.

24. The optical recording/playback device of claim 23, further comprising memory for storing a plurality of correction data sets corresponding respectively to the plurality of aberration correction states; the optical recording/playback device characterized in that:
said aberration control part selectively reads any of said correction data sets from said memory and generates said drive voltages in accordance with said read correction data sets.

25. The optical recording/playback device of claim 2, characterized in that said wavefront aberrations are spherical aberrations which occur as a result of errors in the thickness of said cover layer.

26. The optical recording/playback device of claim 2, characterized in that said lens drive part moves the focal point of said light beam at a first speed before said detection part detects the surface of said cover layer, and moves the focal point of said light beam at a second speed lower than said first speed after said detection part has detected the surface of said cover layer.
